(19) United States
(12) Patent Application Publication
(10) Pub. No.: US 2008/0239435 A1
(43) Pub. Date: Oct. 2, 2008

(54) Light Source Module and Optical Scanning Apparatus Using the Same

(75) Inventor: Tae-Sun Song, Gwangmyeong-dong (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Tae-Sun Song, Gwangmyeong-si (KR)

(21) Appl. No.: 12/065,488

(22) PCT Filed: Aug. 29, 2006
(86) PCT No.: PCT/KR06/03409

§ 371 Date: Feb. 29, 2008

(30) Foreign Application Priority Data
Aug. 29, 2005 (KR) 10-2005-0079155
Sep. 2, 2005 (KR) 10-2005-0081521
Sep. 12, 2005 (KR) 10-2005-0084453
Oct. 10, 2005 (KR) 10-2005-0094709

(51) Int. Cl. G02B 26/08; F21V 21/00

(52) U.S. Cl. 359/204; 362/249

(57) ABSTRACT

The present invention provides a light source module that scans beams so as to realize various images at one time and realizes three-dimensional images, and an optical scanning apparatus using the same. The light source module includes a plurality of light emitting elements that emit modulated light so as to transmit image information, and a fixing member that fixes the light emitting elements such that fixed positions of the respective light emitting elements are different from each other or direction angles of the light emitting elements are different from each other.

### BACKGROUND OF THE INVENTION

(a) Field of the Invention

The present invention relates to a light source module and an optical scanning apparatus using the same. More particularly, the present invention relates to a light source module that scans a beam so as to revive various image screens at one time and that can realize three-dimensional images, and an optical scanning apparatus using the same.

(b) Description of the Related Art

Recently, demand for a large image display devices is increasing. The large image display devices are broadly classified into a direct view type of image display device that is represented by a CRT (cathode-ray tube), a projection type of image display device that is represented by an LCD (liquid crystal display) projector, and an optical scanning type of image display device.

In the CRT, which is a direct view type of image display, red, green, and blue electron beams emitted from red, green, and blue electron guns reach fluorescent points of red, green, and blue color pixels formed on the fluorescent panel in response to red, green, and blue components of a color image signal so as to radiate the fluorescent points of the red, green, and blue color pixels corresponding to the color image signal, so that a color image is displayed on a fluorescent panel. However, in the CRT apparatus, since an absolute moving distance of red, green, and blue electron beams emitted by red, green, and blue electron guns and reaching the fluorescent panel is needed, the overall size and weight of the CRT increases so that it is limited to increase a size of a color image screen of the CRT.

Meanwhile, according to the LCD projector representing the projection type of image display, the weight and the thickness can be reduced and a relatively large image screen can be formed, but since a polarizer is adopted, there is a disadvantage of light loss.

The image display apparatus of an optical scanning type has been proposed in Korean Patent No. 0607644 in the name of the applicant of this application in which two-dimensional scanning is possible by rotating a linear light source without using a rotating multi-surface mirror. However, the image display device disclosed in that application cannot sufficiently display various images. In addition, the image display device disclosed in that application has a drawback in that it is difficult to realize three-dimensional images.

### SUMMARY OF THE INVENTION

The present invention has been made in an effort to provide a light source module having an advantage of realizing various images so as to produce various results, thereby enhancing the marketability of the product and an optical scanning apparatus using the same.

In addition, the present invention has been made in an effort to provide a light source module having an advantage of producing three-dimensional images that can be seen without glasses for seeing three-dimensional images and an optical scanning apparatus using the same.

An exemplary embodiment of the present invention provides a light source module including a plurality of light emitting elements that emit modulated light so as to transmit image information, and a fixing member that fixes the light emitting elements such that fixed positions of the respective light emitting elements are different from each other or direction angles of the light emitting elements are different from each other.

The fixing member may include a base, and projections disposed on the base with a constant interval therebetween and respectively having surfaces at a height different from a surface formed by the base.

A side surface of the projection may be formed to be slanted.

The light emitting elements may be arranged on the fixing member in at least one row.

The projections may be arranged in at least one row.

The projections may be formed as truncated circular cones.

The projections may be formed as truncated quadrangular cones.

The projections may be provided with other projections thereon that are formed as truncated quadrangular cones.

The projections provided to the base may be formed by curved surfaces extending from the base.

The surfaces being formed at different heights that are provided to the fixing member may be continuously formed along a length direction.

The surfaces may be formed to be curved.

A side part of the surfaces may be slanted.

An exemplary embodiment of the present invention provides an optical scanning apparatus using a light source module including a plurality of light emitting elements that emit modulated light so as to transmit image information, and a fixing member that fixes the light emitting elements such that fixed positions of the respective light emitting elements are different from each other or direction angles of the light emitting elements are different from each other.

The light emitting elements may be realized by a light emitting diode, and in particular, a surface light emitting diode.

### BRIEF DESCRIPTION OF THE DRAWINGS

FIG. 1 is a perspective view for explaining an example to which an exemplary embodiment of the present invention is applied.

FIG. 2 is a cross-sectional view taken along a line II-II in FIG. 1.

FIG. 3 is a perspective view showing primary parts of a first embodiment of the present invention.

FIG. 4 is a top plan view of FIG. 3.

FIG. 5 is a perspective view for describing a second embodiment of the present invention.

FIG. 6 is a perspective view for describing a third embodiment of the present invention.

FIG. 7 is a perspective view for describing a fourth embodiment of the present invention.

FIG. 8 is a perspective view for describing a fifth embodiment of the present invention.

FIG. 9 is a perspective view for describing a sixth embodiment of the present invention.

FIG. 10 is a perspective view for describing a seventh embodiment of the present invention.

FIG. 11 is a perspective view for describing an eighth embodiment of the present invention.

FIG. 12 is a perspective view for describing a ninth embodiment of the present invention.

FIG. 13 is a perspective view for describing a tenth embodiment of the present invention.

FIG. 14 is a perspective view for describing an eleventh embodiment of the present invention.

FIG. 15 is a perspective view for describing a twelfth embodiment of the present invention.

### DETAILED DESCRIPTION OF THE EMBODIMENTS

Exemplary embodiments of the present invention will hereinafter be described in detail with reference to accompanying drawings.

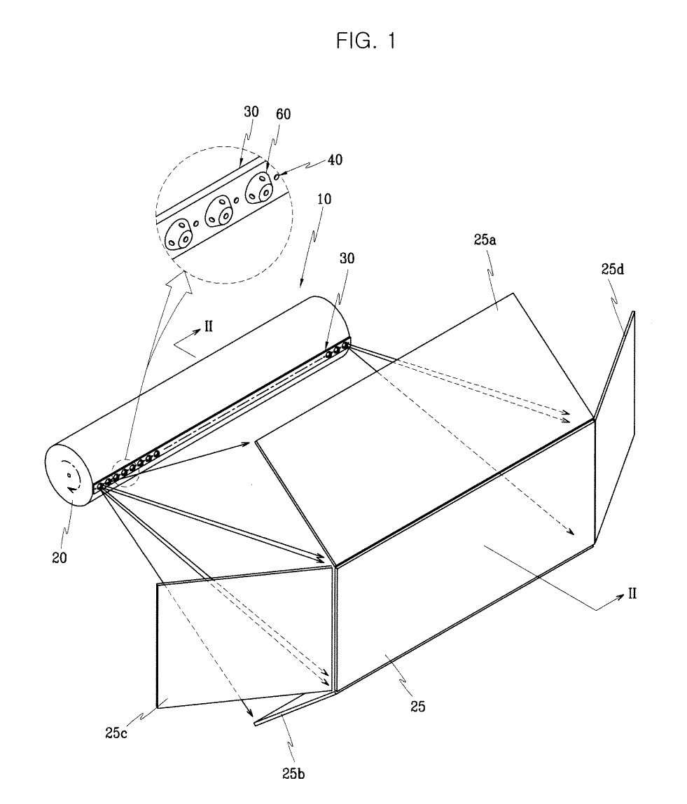

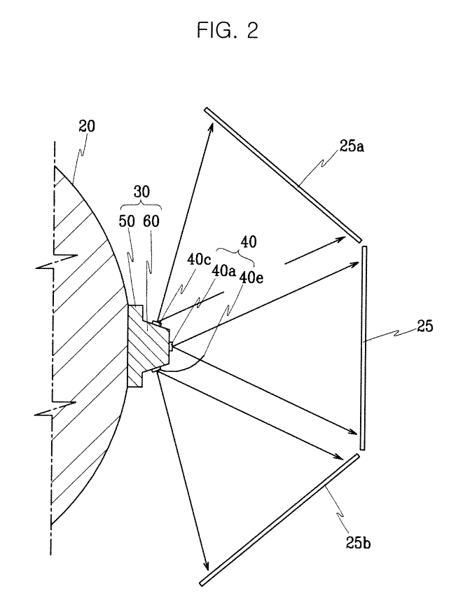

FIG. 1 is a perspective view for explaining an example to which an exemplary embodiment of the present invention is applied, and FIG. 2 is a cross-sectional view taken along a line II-II in FIG. 1 and illustrates an optical scanning apparatus for an image display apparatus. An optical scanning apparatus 10 may include a cylindrical drum 20 that is connected to a driving device (not shown) such as a motor, and a light source module disposed on an outer surface of the drum 20. The optical scanning apparatus 10 may scan light on a screen 25 or the like so as to realize an image. However, the present invention is not limited to this example, and the optical scanning apparatus 10 may emit light so as to directly display an image that can be seen by a user, without the screen 25.

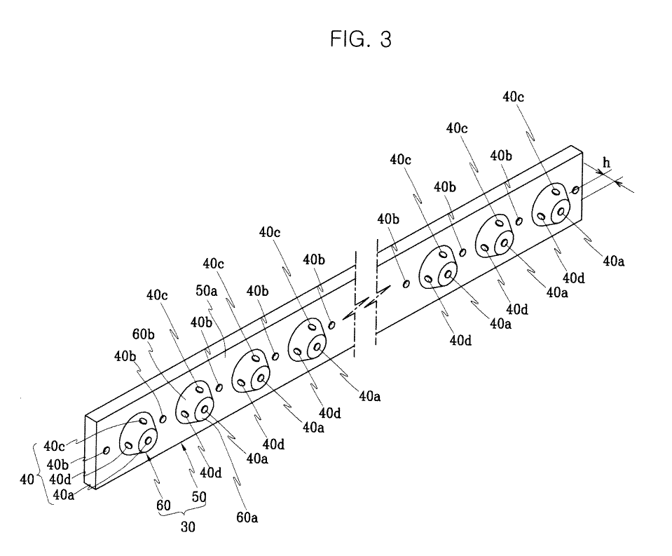

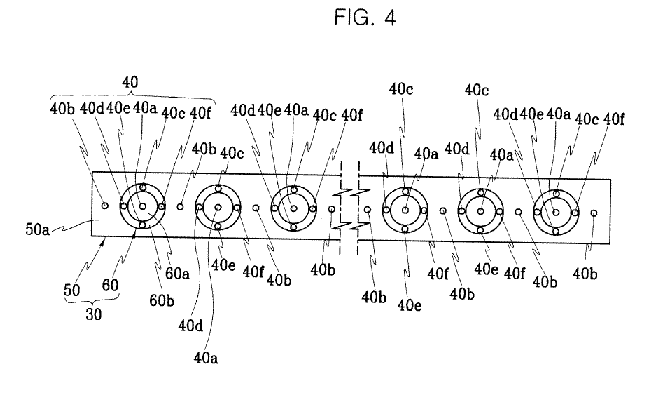

FIG. 3 is a perspective view showing primary parts of a first embodiment of the present invention, and FIG. 4 is a plan view of FIG. 3 and illustrates a light source module. The light source module according to an embodiment of the present invention includes a fixing member 30 and a light emitting element 40. The fixing member 30 includes a base 50, which can be formed in a shape of a bar having a specific length, and projections 60 that are repeatedly disposed on the base 50 and have surfaces having a height difference h (shown in FIG. 3) from a surface formed by the base 50. Although the base 50 and the projections 60 may be formed by combining separate members, it is preferable that the base 50 and the projections 60 are integrally formed as a single body. In the first embodiment of the present invention, the projections 60 may be formed as circular cones, an end portion of which is cut, i.e., truncated circular cones. That is, the light source module according to the first exemplary embodiment of the present invention has a structure in which the projections 60 formed as truncated circular cones are arranged in a row on the fixing member 30 having a specific length. That is, there is a specific height difference h (shown in FIG. 3) between a surface 50a formed by the base 50 and a surface 60a formed by the projection 60. In this case, surfaces 60a of the projection 60 may preferably be formed at the same height.

Light emitting elements 40a, 40b, 40c, 40d, 40e, and 40f (referring to FIG. 3 and FIG. 4) may be coupled to the surface 60a of the projection 60, a surface 50a forming the base 50 between the projections 60, and a side surface 60b of the projection 60. The light emitting elements 40c, 40d, 40e, and 40f (referring to FIG. 4) coupled to the side surface 60b of the projection 60 may be regularly arranged at a front side, a rear side, a left side, and a right side. The light emitting elements 40 are arranged such that the light emitting elements 40a disposed on the surface 60a of the projection 60 form one row and other light emitting elements 40b disposed on the surface 50a forming the base 50 between the projections 60 form the same row with the light emitting elements 40a with a height difference. The light emitting elements 40c and 40e disposed on the slanted side surface 60b of the projection 60 form a different row from the row of the light emitting elements 40a, and have a different direction angle by the inclination. The light emitting elements 40d and 40f disposed on the slanted side surface 60b of the projection 60 form the same row with the light emitting elements 40a, but have a different light scanning direction by the inclination so as to have a different direction angle.

The light emitting element 40 that can be applied to the present invention emits modulated light of red, green, and blue colors corresponding to an image displayed in a shape in which laser diodes or light emitting diodes are arranged in a row.

Operations of the first exemplary embodiment of the present invention will be explained in detail hereinafter. The light emitting element 40 can scan images while moving in a direction perpendicular to a length direction of the fixing member 30. Further detailed explanation will be made using an example of the light emitting element 40 scanning in this way. A person who sees images at a front center can mainly see the light emitting elements 40a on the surface 60a of the projection 60 and the light emitting elements 40b disposed on the surface 50a between the projections 60. A person who sees images at a left side can see the light emitting elements 40d disposed on a left side surface of the projection 60, and a person who sees images at a right side can mainly see the light emitting elements 40f disposed on a right side surface of the projection 60. Accordingly, left and right images can be formed to be different from each other, and the light emitting elements are independently modulated so that different images can be illuminated on left and right eyes of a viewer. That is, when a viewer sees the light emitting element, the center light emitting elements 40a and 40b, the light emitting elements 40d and 40f that scan to the left and the right, or the light emitting elements 40c and 40e that scan to the upper side and the lower side scan to different spaces, and the center light emitting elements 40a and 40b scan to different spaces by the height difference h, so that three-dimensional images can be displayed. In the case that the light emitting elements of the light source having different heights scan, a feeling of depth of the light source may be endowed to viewers. In addition, since the light emitting elements emit light at different direction angles, for example, the light emitting elements that scan to the left and the right scan to the left and the right depending on position, one of them cannot be seen according to a seeing direction, so that images that are actually seen become different depending on a scanning position and a position of a viewer. For example, in the case that the light source scans while moving from the left to the right and a viewer is positioned at the center, light emitted from the light emitting element in a direction angle that is slanted to the left cannot reach eyes of the viewer while scanning from the left scanning start point to the front (center) of the viewer, but can easily reach eyes of the viewer while scanning from the front (center) of the viewer to the right scanning end point. To the contrary, light emitted from the light emitting element a direction angle that is slanted to the right reaches eyes of the viewer while scanning from the left scanning start point to the front (center) of the viewer, but cannot reach eyes of the viewer while scanning from the front (center) of the viewer to the right scanning end point. Accordingly, a range of the light source that can be seen varies depending on a direction angle of the right emitting element and a position of the viewer, and the viewer can perceive the depth according to the height of the light emitting elements, so that images having an excellent feeling of solidity can be scanned.

Accordingly, clear three-dimensional images can be enjoyed without separate glasses for three-dimensional images.

Meanwhile, in the exemplary embodiment of the present invention, the region at which light arrives can be varied by the light emitting element, so that different images can be seen according to a view position.

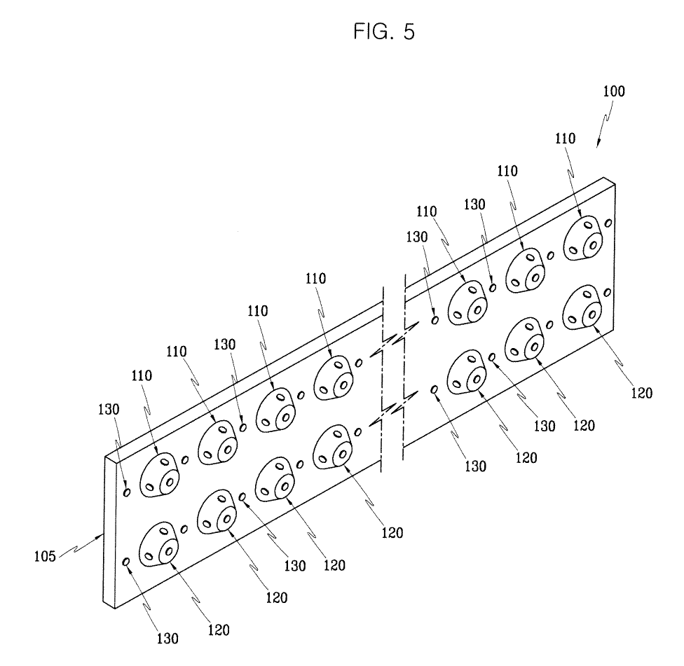

FIG. 5 is a drawing describing the second exemplary embodiment of the present invention, and illustrates a light source module. Explanations of the second exemplary embodiment of the present invention will be made for only parts that are different from the first exemplary embodiment of the present invention, and explanations for the like parts will be omitted. In the second exemplary embodiment of the present invention, a fixing member 100 includes a base 105 and projections 110 and 120 arranged in two rows on the base 105. The projections 110 and 120 arranged in two rows are respectively formed as truncated circular cones like in the first exemplary embodiment of the present invention. Light emitting elements 130 (only a portion of the light emitting elements are designated by the reference numeral for convenience of description) are disposed in the same manner as the first exemplary embodiment of the present invention. In the second exemplary embodiment of the present invention, if the amount of light of the light source is deficient, an object of the present invention can be achieved by adding additional light emitting elements, and the second exemplary embodiment of the present invention shows that the present invention can be executed in various ways.

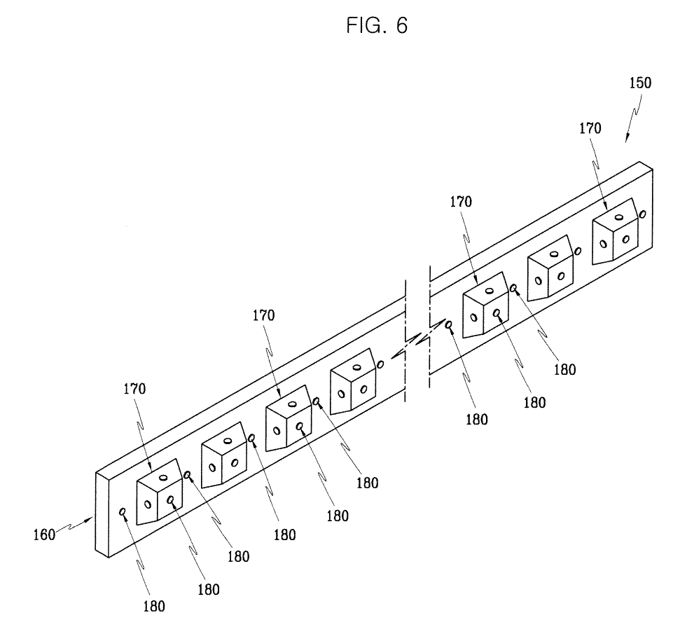

FIG. 6 is a drawing describing the third exemplary embodiment of the present invention, and illustrates a light source module. Explanations of the third exemplary embodiment of the present invention will be made for only parts that are different from the first exemplary embodiment of the present invention, and explanations for the like parts will be omitted. In the third exemplary embodiment of the present invention, projections 170 provided to a base 160 constituting a fixing member 150 are arranged in a row, and have a quadrangular cone shape, an upper portion of which is cut, i.e., a truncated quadrangle cone shape. Light emitting elements 180 (only a portion of light emitting elements are designated by the reference numeral for convenience of description) may be disposed on a surface of the base 160 between the projections 170 and surfaces formed by the projections 170. The third exemplary embodiment of the present invention shows that the present invention can be executed in various ways.

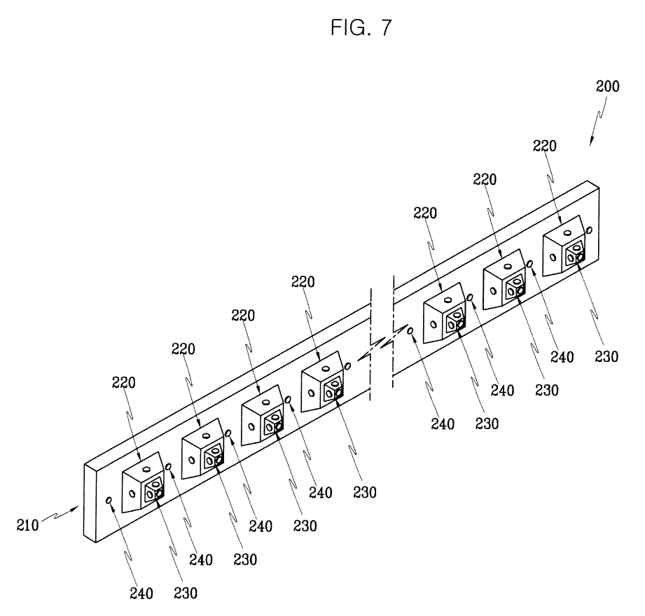

FIG. 7 is a drawing describing the fourth exemplary embodiment of the present invention, and illustrates a light source module. Explanations of the fourth exemplary embodiment of the present invention will be made for only parts that are different from the third exemplary embodiment of the present invention, and explanations for the like parts will be omitted. A fixing member 200 of the fourth exemplary embodiment of the present invention is provided with first projections 220 with a shape of a quadrangle cone, an upper portion of which is cut, i.e., a truncated quadrangle cone, at an upper surface of the base 210. In addition, second projections 230 are provided at an upper surface of the first projection 220. The second projections 230 may be formed in a shape of a quadrangle cone, an upper portion of which is cut, i.e., a truncated quadrangle cone, similar to the first projection 220. The light emitting elements 240 may be preferably disposed on surfaces of the first projections 220 and the second projections 230, and a surface of the base 210 between the first projections 220. The fourth exemplary embodiment of the present invention has the same operations and effects as the above-described exemplary embodiments of the present invention, but can achieve the object of the present invention through different structures.

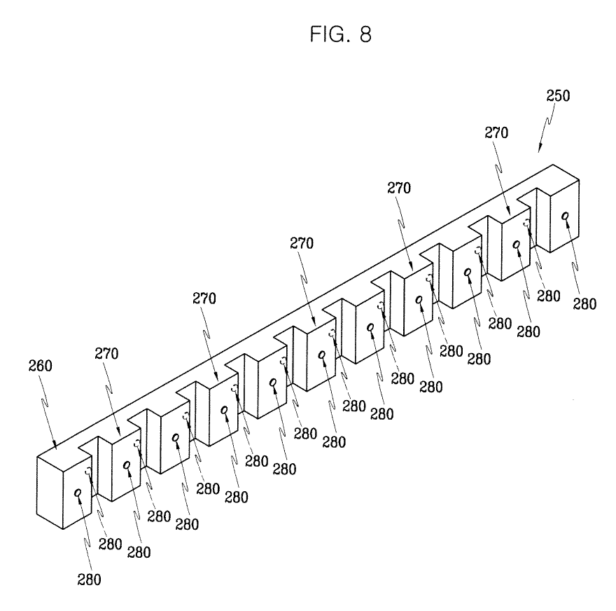

FIG. 8 is a drawing describing the fifth exemplary embodiment of the present invention, and illustrates a light source module. Explanations of the fifth exemplary embodiment of the present invention will be made for only parts that are different from the first exemplary embodiment of the present invention, and explanations for the like parts will be omitted. A fixing member 250 of the fifth exemplary embodiment of the present invention includes a base 260 and a plurality of projections 270 arranged on the base at different heights. That is, the projections 270 have a surface formed at a different height from a surface formed by the base 260, and the projections 270 are repeatedly disposed. In addition, light emitting elements 280 may be disposed on surfaces formed by the projections 270 and surfaces formed by the base 260 between the projections 270. Alternatively, the base 260 may be formed to have grooves so as to form the projections 270 having different surfaces in turn.

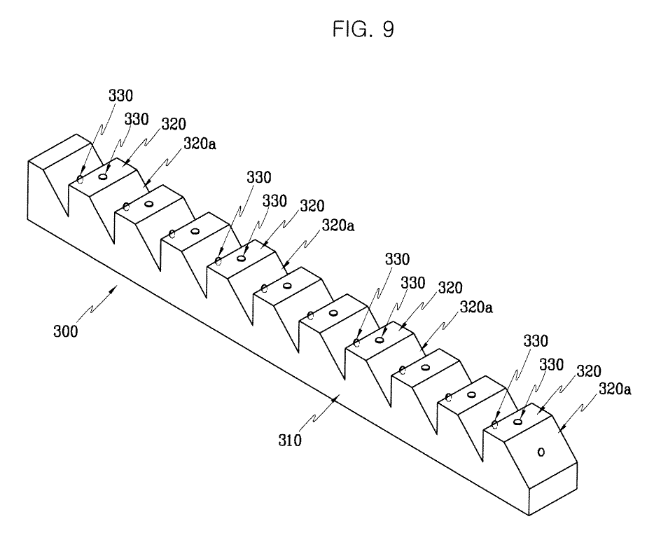

FIG. 9 is a drawing describing the sixth exemplary embodiment of the present invention, and illustrates a light source module. Explanations of the sixth exemplary embodiment of the present invention will be made for only parts that are different from the fifth exemplary embodiment of the present invention, and explanations for the like parts will be omitted. A fixing member 300 of the sixth exemplary embodiment of the present invention includes a base 310 and projections 320 provided to the base 310, and a side surface of the projection 320 is formed as a slanted surface 320a. In addition, light emitting elements 330 may be disposed on upper surfaces formed by the projections 320 and the slanted surfaces 320a. In the exemplary embodiment of the present invention, the base 310 and the projections 320 may preferably be integrated in a single member. The sixth exemplary embodiment of the present invention shows that the object of the present invention can be achieved in various ways.

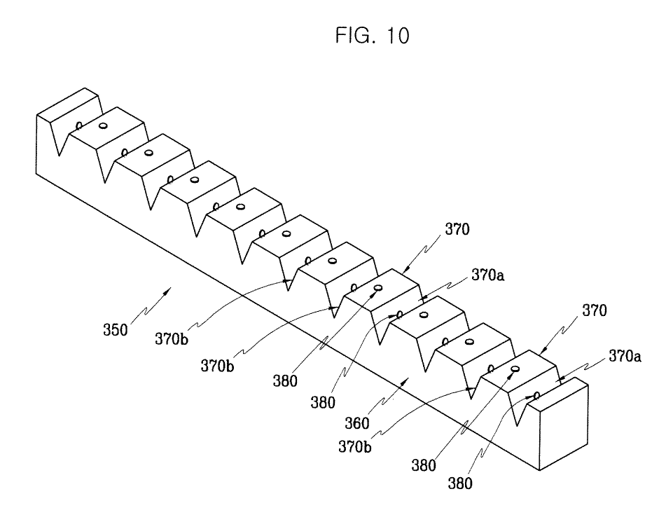

FIG. 10 is a drawing describing the seventh exemplary embodiment of the present invention, and illustrates a light source module. Explanations of the seventh exemplary embodiment of the present invention will be made for only parts that are different from the sixth exemplary embodiment of the present invention, and explanations for the like parts will be omitted. A fixing member 370 of the seventh exemplary embodiment of the present invention includes a base 360 and projections 370 formed on the base 360, and both side surfaces of the projections 370 are respectively formed as slanted surfaces 370a and 370b. Light emitting elements 380 may be disposed on upper surfaces formed by the projections 370 and the slanted surfaces 370a and 370b. In the exemplary embodiment of the present invention, the base 360 and the projections 370 may preferably be integrated in a single member. One side surface of each projection is formed with the slanted surface as in the sixth exemplary embodiment of the present invention, but in the seventh exemplary embodiment of the present invention, both side surfaces of the projection are formed with the slanted surface. The seventh exemplary embodiment of the present invention shows that the object of the present invention can be achieved in various ways.

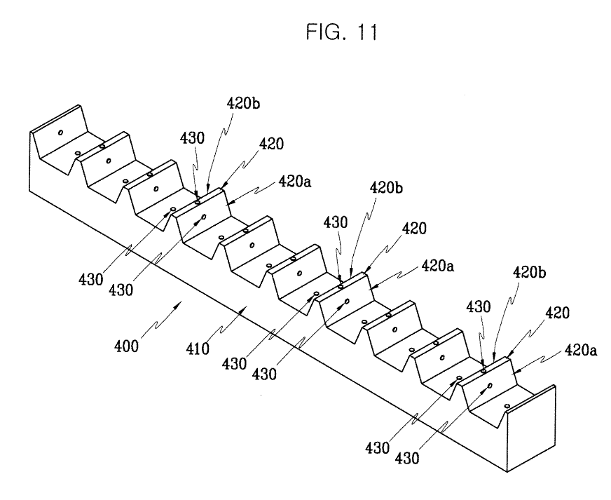

FIG. 11 is a drawing describing the eighth exemplary embodiment of the present invention, and illustrates a light source module. Explanations of the eighth exemplary embodiment of the present invention will be made for only parts that are different from the seventh exemplary embodiment of the present invention, and explanations for the like parts will be omitted. A fixing member 400 of the eighth exemplary embodiment of the present invention includes a base 410 and projections 420 formed on the base 410, and both side surfaces of the projection 420 are respectively formed as slanted surfaces 420a and 420b. Light emitting elements 430 may be disposed on upper surfaces formed by the projections 420 and the slanted side surfaces 420a and 420b. In particular, when compared to the seventh exemplary embodiment of the present invention, the upper surface of each projection 420 of the eighth exemplary embodiment of the present invention is formed to be very narrow. This example also shows that the present invention can be executed in various ways. In the exemplary embodiment of the present invention, the base 410 and the projections 420 may preferably be integrated in a single member. The eighth exemplary embodiment of the present invention shows that the object of the present invention can be achieved in various ways.

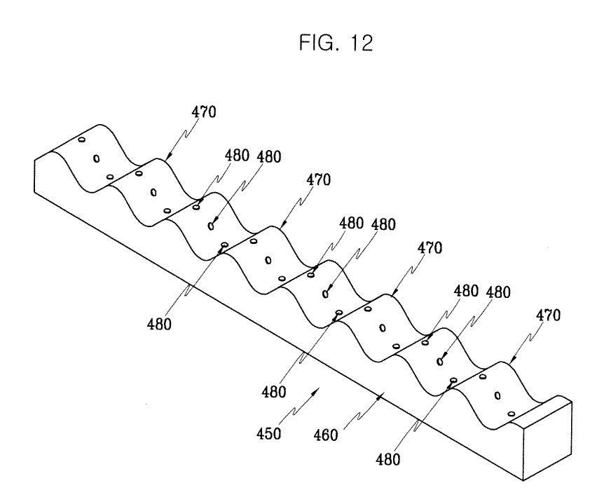

FIG. 12 is a drawing describing the ninth exemplary embodiment of the present invention, and illustrates a fixing member 450. Explanations of the ninth exemplary embodiment of the present invention will be made for only parts that are different from the seventh exemplary embodiment of the present invention, and explanations for the like parts will be omitted. The fixing member 450 includes a base 460 and projections 470 extended from the base 460, and the projections 470 are formed in a shape to be connected to one another by a curved surface. Light emitting elements 480 are coupled to the curved surfaces. The ninth exemplary embodiment of the present invention shows that the object of the present invention can be achieved in various ways.

The above-described structure is configured so as to maximize a difference of light of the light emitting element reaching left and right eyes, and in particular, in the case of FIG. 10, FIG. 11, and FIG. 12, if light is scanned to the upper side and the lower side, this effect can be maximized. To the contrary, it can be known that in the case of FIG. 3, FIG. 6, and FIG. 7, different images can be seen at the right and the left side irregardless of the scanning direction.

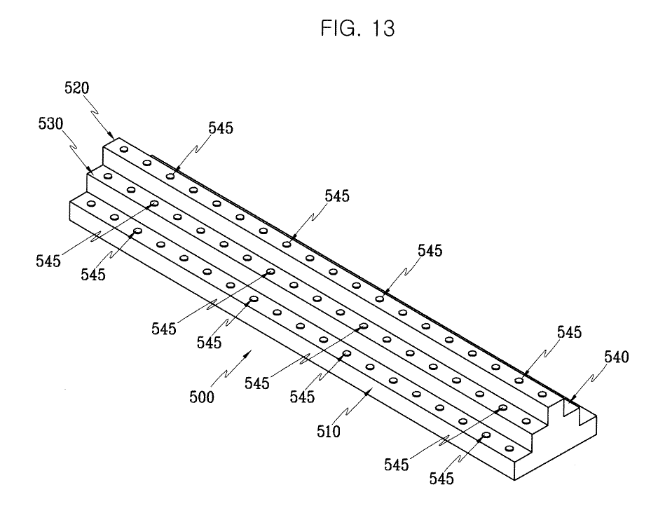

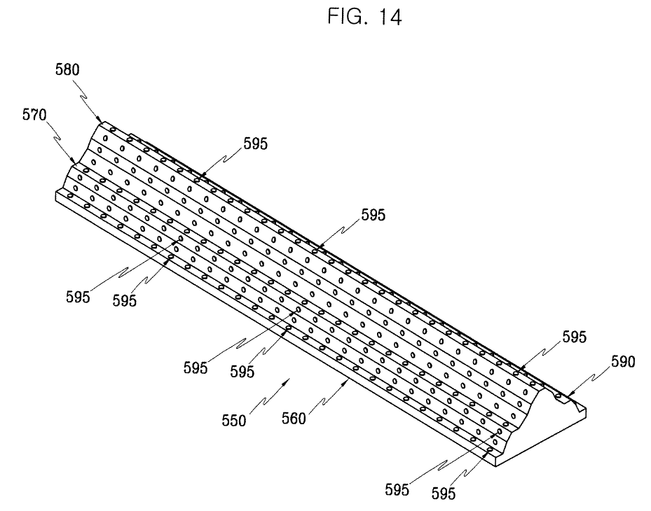

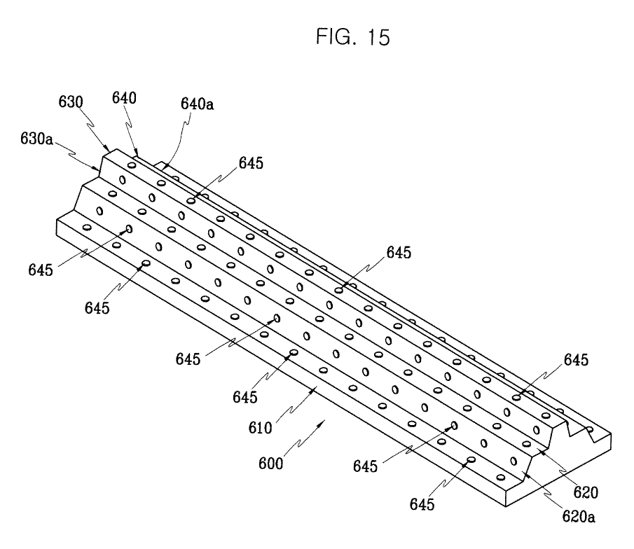

In the case of FIG. 13, FIG. 14, and FIG. 15, if light is scanned in the left direction and the right direction, a difference between the left image and the right image of a viewer can be more effectively seen. This is explained with an example in which the fixing members are disposed in a vertical direction and undergoes a parallel movement or a rotational movement in a horizontal direction.

FIG. 13 is a drawing describing the tenth exemplary embodiment of the present invention, and illustrates a fixing member 500. Explanations of the tenth exemplary embodiment of the present invention will be made for only parts that are different from the fifth exemplary embodiment of the present invention, and explanations for the like parts will be omitted. In the tenth exemplary embodiment of the present invention, the fixing member 500 is formed to have a shape of stairs in a direction perpendicular to a length direction thereof. The fixing member 500 includes a base 510 and projections 520, 530, and 540 extending from the base 510. The projections 520, 530, and 540 form the same surfaces along a length direction of the base 510, and light emitting elements 545 may be disposed on the surfaces. The tenth exemplary embodiment of the present invention shows that the object of the present invention can be achieved in various ways.

FIG. 14 is a drawing describing the eleventh exemplary embodiment of the present invention, and illustrates a fixing member 550. Explanations of the eleventh exemplary embodiment of the present invention will be made for only parts that are different from the tenth exemplary embodiment of the present invention, and explanations for the like parts will be omitted. In the eleventh exemplary embodiment of the present invention, the fixing member 550 is formed to have a shape of stairs in a direction perpendicular to a length direction thereof. The fixing member 550 includes a base 560 and projections 570, 580, and 590 extending from the base 560. The projections 570, 580, and 590 form the same surfaces along a length direction of the base 550, and light emitting elements 595 may be disposed on the surfaces. In particular, in the eleventh exemplary embodiment of the present invention, parts connecting the projections 570, 580, and 590 may be formed as a curved surface or a slanted surface. The light emitting elements 595 may be disposed on surfaces forming the projections 570, 580, and 590. The eleventh exemplary embodiment of the present invention shows that the object of the present invention can be achieved in various ways.

FIG. 15 is a drawing describing the twelfth exemplary embodiment of the present invention, and illustrates a fixing member 600. Explanations of the twelfth exemplary embodiment of the present invention will be made for only parts that are different from the eleventh exemplary embodiment of the present invention, and explanations for the like parts will be omitted. In the twelfth exemplary embodiment of the present invention, the fixing member 600 is formed to have a shape of stairs in a direction perpendicular to a length direction thereof. The fixing member 600 includes a base 610 and projections 620, 630, and 640 extending from the base 610. The projections 620, 630, and 640 form the same surfaces along a length direction of the base 610, and light emitting elements 645 may be disposed on the surfaces. In particular, in the twelfth exemplary embodiment of the present invention, parts connecting the projections 620, 630, and 640 may be formed as slanted surfaces 620a, 630a, and 640a. Light emitting elements 645 may be disposed on the surfaces formed by the projections 620, 630, and 640 and the slanted surfaces 620a, 630a, and 640a. The eleventh exemplary embodiment of the present invention shows that the object of the present invention can be achieved in various ways. As such, the present invention can be variously realized by the combination of the exemplary embodiments of the present invention or variations of the exemplary embodiments of the present invention. For example, the present invention can be realized in a method in which the fixing member and the light emitting elements are formed by being combined with a flexible PCB, a shape of which can be easily changed.

In addition, without changing a physical height of the fixing member or forming the slanted surface, a depth feeling or a direction angle of the light source can be changed using an optical device, etc. For example, an apparent light emitting position of the light emitting elements positioned on the same surface can be changed can be changed using an optical device such as a lens. In addition, a direction angle of light emitted from the light source can be adjusted using an optical device such as a prism that can change the directional characteristic of emitted light.

As such, according to the present invention, the light emitting elements are disposed on the fixing member in at least one row at different heights or they scan light in different direction angles, so a three-dimensional image can be realized.

In particular, according to the present invention, a three-dimensional image can be seen without using glasses for seeing three-dimensional images.

In addition, the light emitting elements emit light at different positions, and the emitted light is scanned in different directions, so that images can be realized in various ways to thereby enhance the marketability of the product.

1. A light source module, comprising:
a plurality of light emitting elements that emit modulated light so as to transmit image information; and
a fixing member that fixes the light emitting elements such that fixed positions of the respective light emitting elements are different from each other or direction angles of the light emitting elements are different from each other,
wherein the fixing member comprises:
a base; and
projections disposed on the base with a constant interval therebetween, and respectively having surfaces at a height that is different from a surface formed by the base.

2. (canceled)

3. The light source module of claim 1, wherein a side surface of the projection is formed to be slanted.

4. The light source module of claim 1, wherein the light emitting elements are arranged on the fixing member in at least one row.

5. The light source module of claim 1, wherein the projections are arranged in at least one row.

6. The light source module of claim 1, wherein the projections are formed as truncated circular cones.

7. The light source module of claim 1, wherein the projections are formed as truncated quadrangular cones.

8. The light source module of claim 7, wherein the projections are provided with other projections thereon that are formed as truncated quadrangular cones.

9. The light source module of claim 1, wherein the projections provided to the base are formed by curved surfaces extending from the base.

10. The light source module of claim 1, wherein the surfaces being formed at different heights from the surface formed by the base that are provided to the fixing member are continuously formed along a length direction.

11. The light source module of claim 10, wherein the surfaces are formed as curved surfaces.

12. The light source module of claim 10, wherein a side part of the surfaces is slanted.

13. An optical scanning apparatus using a light source module, the light source module comprising:
a plurality of light emitting elements that emit modulated light so as to transmit image information; and
a fixing member that fixes the light emitting elements such that fixed positions of the respective light emitting elements are different from each other or direction angles of the light emitting elements are different from each other,
wherein the fixing member comprises:
a base; and
projections disposed on the base with a constant interval therebetween, and respectively having surfaces at a height that is, different from a surface formed by the base.

14. (canceled)

15. The optical scanning apparatus of claim 13, wherein the light emitting elements are arranged on the fixing member in at least one row.

16. The optical scanning apparatus of claim 13, wherein the projections are arranged in at least one row.
